(19) United States
(12) Patent Application Publication
(10) Pub. No.: US 2012/0237816 A1
(43) Pub. Date: Sep. 20, 2012

(54) LOW-COST HIGH-POWER BATTERY AND ENABLING BIPOLAR SUBSTRATE

(75) Inventors: Martin R. Roscheisen, San Francisco, CA (US); Brent J. Bollman, San Jose, CA (US); Hak Fei Poon, Mountain View, CA (US); Zhengyu Wu, Shanghai (CN); Boris Monahov, Morrisville, NC (US); Sam Kao, Los Altos, CA (US)

(73) Assignee: YottaQ, Inc., Sunnyvale, CA (US)

(21) Appl. No.: 13/048,757

(22) Filed: Mar. 15, 2011

(51) Int. Cl. H01M 10/18; B05D 5/12; H01M 10/04; H01M 10/02

(52) U.S. Cl. 429/156; 429/210; 427/58; 427/122; 427/123

(57) ABSTRACT

A bipolar battery may include a substrate having a matrix made of a thermoset polymer formed from a liquid precursor. One or more conductive pellets can be disposed in the matrix to provide electrical connection between opposite sides of the matrix. Each conductive pellet has a characteristic thickness that is greater than a thickness of the matrix. Each of the one or more conductive pellets protrudes beyond first and second surfaces of the matrix.

### FIELD OF THE INVENTION

This Application is related to electric storage batteries and more specifically to low-cost high-power batteries.

### BACKGROUND OF THE INVENTION

Batteries can be either primary or secondary type, with the secondary type having the capability to be charged and discharged repeatably. There are a number of different types of secondary battery technologies. One of the oldest and most widely used is the lead acid storage battery. Lead acid storage batteries can use either a monopolar, bipolar design (alternate configurations exist, such as a so-called quasi-bipolar design). Monopolar lead acid storage batteries generally have a structure in which spaces in lead grid plates are filled with a paste referred to as the active materials, containing a formulation of lead, acid and special additives in the form of a viscous clay, having a consistency akin to cement or concrete. In a monopolar battery, the grid plates are stacked in alternating arrangement with tabs on alternate plates connected to plus or minus electrodes with lead.

A battery with a bipolar configuration is known to be advantageous over the conventional monopolar configuration in terms of power output. In a conventional battery with a monopolar configuration, current generated by active materials travels to a current collector and through a lead interconnect (known as top lead) to reach the next cell. In a bipolar configuration, active materials of opposite polarities are placed on the two surfaces of a bipolar substrate. Current can thus flow through the substrate to the next cell. Because of a much shorter electrical path, power loss due to ohmic drop in the circuit is minimized. The volume of the battery is reduced due to elimination of the outer circuit materials such as straps, posts and tabs. In one bipolar battery design a porous bipolar plate is sandwiched between two acid glass mats (AGM). Each AGM is a glass fiber matt that absorbs the acid. This structure is in turn sandwiched between a positive active material (PAM) and a negative active material (NAM).

In a bipolar lead/acid battery, the role of the substrate is paramount. The substrate serves as an inter-cell connection and as a support to active materials. The substrate also provides seals between the individual cells and isolates the cells from each other. The substrate must retain its electrical conductivity in the corrosive lead/acid environment and break communication of electrolyte in adjacent cells through the service life of the battery. Furthermore, the substrate may not participate in or provide alternative routes to the battery reactions. These requirements call for a substrate that is electrically conductive, insoluble in sulfuric acid, stable in the potential window of the battery, having high oxygen and hydrogen overpotentials. Furthermore, the substrate should be inert to battery reactions, impervious to the electrolyte, have good adhesion to the battery active materials, and be easy to process and seal to the battery case.

British Patent Number 226,857 describes an early bipolar lead/acid battery that used lead sheet as the substrate. The active materials were formed on the substrate. The sheets were stacked between U-shaped rubber gaskets. This type of bipolar lead/acid battery had problems with sealing, substrate corrosion, and lack of capacity. Another bipolar battery configuration used a titanium sheet glued onto a lead sheet with conductive adhesives. Titanium tends to passivate at the potential of a lead-acid battery and attempts to protect it with a coating of gold or lead add weight or cost.

Other configurations have used gold-plated titanium or conductive plastic as the substrate material. This latter configuration was given up due to difficulties in making a pore-free gold plate and working the titanium into a usable configuration. Attempts to use commercially available conductive epoxides with conductive fillers (e.g., carbon, graphite, copper, or silver) were unsuccessful due to reaction with the cell environment. Attempts to use vitreous carbon powder as an epoxy filler were initially successfully. Unfortunately, attempts to paste and form active materials on this substrate were unsuccessful due to interfacial corrosion on the positive side of the substrate.

Attempts to find suitable ceramic materials for use as substrate indicated that very few of the ceramic materials screened possess desired properties to be applicable in a bipolar substrate for a lead/acid battery. Among 120 candidates, silicides of Ti, Nb and Ta were identified as acceptable for composite substrates. However, fabrication of a workable substrate using such materials would require texturing or lamination with a lead foil to interface the substrate and active materials is necessary to improve paste adhesion. See Weng-Hong Kao, in “Substrate materials for bipolar lead/acid batteries” in Journal of Power Sources, 1998, Elsevier Science S.A, pp 8-15.

Thus, there is a need in the art, for an improved bipolar lead-acid battery that overcomes the aforementioned drawbacks.

### BRIEF DESCRIPTION OF THE DRAWINGS

The teachings of the present invention can be readily understood by considering the following detailed description in conjunction with the accompanying drawings, in which:

FIG. 1A is a three-dimensional schematic diagram of a substrate for a bipolar battery according to an embodiment of the present invention.

FIG. 1B is a cross-sectional schematic diagram of the substrate of FIG. 1A.

FIG. 1C is a three-dimensional schematic diagram of a substrate for a bipolar battery according to an alternative embodiment of the present invention.

FIG. 1D is a cross-sectional schematic diagram of the substrate of FIG. 1C.

FIG. 2A is an exploded three-dimensional diagram of a bipolar battery cell according to an embodiment of the present invention.

FIG. 2B is an exploded three-dimensional diagram of a bipolar battery according to an embodiment of the present invention.

FIG. 2C is a cross-sectional schematic diagram of the bipolar battery of FIG. 2B.

FIGS. 3A-3G are a sequence of cross-sectional schematic diagrams illustrating a method for fabricating a substrate for a bipolar battery according to an embodiment of the present invention.

FIG. 4A is a three-dimensional schematic diagram of a substrate for a bipolar battery according to an alternative embodiment of the present invention.

FIG. 4B is a cross-sectional schematic diagram of the substrate of FIG. 4A.

FIG. 4C is a three-dimensional schematic diagram of a substrate for a bipolar battery according to another alternative embodiment of the present invention.

FIG. 4D is a cross-sectional schematic diagram of the substrate of FIG. 4C.

FIG. 4E is a three-dimensional schematic diagram illustrating an alternative configuration for a bipolar substrate according to an alternative embodiment of the present invention.

FIG. 4F is a cross-sectional schematic diagram of the substrate of FIG. 4E.

FIG. 4G is a three-dimensional schematic diagram of a conductive grid for another alternative configuration of a substrate for a bipolar battery.

FIGS. 4H-4I are cross-sectional schematic diagrams illustrating an alternative configuration of a substrate for a bipolar battery that utilizes the conductive grid of FIG. 4G.

FIG. 5A is an exploded three-dimensional diagram of a bipolar battery cell according to an alternative embodiment of the present invention.

FIG. 5B is an exploded three-dimensional diagram of a bipolar battery according to an alternative embodiment of the present invention.

FIG. 5C is a cross-sectional schematic diagram of the bipolar battery of FIG. 5B.

FIGS. 6A-6D are a sequence of cross-sectional schematic diagrams illustrating a method for fabricating a substrate for a bipolar battery according to an alternative embodiment of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

### INTRODUCTION

The main problems with both types of lead-acid battery designs are low materials utilization, high weight and corrosion of the components by the acid. These two problems are related. The acid tends to corrode the grid in a monopolar battery. Lead is used because it is corrosion resistant, which means that it corrodes relatively slowly. However, since lead does corrode, albeit slowly, relatively thick lead plates are used to provide sufficient lifetime for the battery. This increases the weight and cost of the battery.

The bipolar design reduces the amount of lead by eliminating the grids and using a bipolar plate to separate the positive and negative sides of the battery. However, the bipolar plate is likely to corrode. To resist corrosion, the bipolar plate can be made thicker, but this defeats the benefit of low weight.

U.S. Pat. No. 4,658,499 to Rowlette describes a bipolar battery substrate in which conductive spherical elements are inserted into apertures in a thermoplastic resin. Heat and pressure are applied to the resin to deform the spherical elements into an approximately cylindrical shape and to melt, stretch and compress the surrounding plastic resin to provide a liquid impermeable sheath around the element. Because this substrate uses a thermoplastic resin, the apertures must be formed before inserting the spherical elements and the thermoplastic resin must be partially melted to seal the elements to the resin. Unfortunately, melting the plastic produces inadequate surface bonding of the elements to the plastic. This, in turn, can lead to permeation of liquid across the substrate, which can destroy the function of the battery.

### SOLUTION TO THE PROBLEM

Embodiments of the present invention overcome the problems with prior art bipolar batteries through the use of a novel bipolar battery substrate architecture in which conductive pellets are embedded into a thermoset polymer matrix. Electrical conduction takes place across the matrix through the pellets. Because pellets are spaced apart by the matrix there is little conduction parallel in the matrix (the active materials and lead foil transport current laterally to get to the spheres). The relatively large area of the pellets provides sufficient conductance (i.e., relatively low internal resistance). Use of a thermoset polymer formed from a liquid precursor provides good adhesion between the pellets and the matrix, thereby reducing permeation of active materials or electrolyte across the substrate.

As used herein the term “thermoset polymer” refers to a polymer that is irreversibly cured. Such polymers are sometimes known as thermosetting plastic, or simply as a thermoset. The cure may be done through application of heat (e.g., above 200° C. (392° F.)), through a chemical reaction (as in a two-part epoxy, for example), or through suitable irradiation such as ultraviolet light or electron beam. As is generally understood, thermoset polymers are can be formed from a liquid or malleable precursor prior to curing and designed to be molded into their final form, or used as adhesives. Other thermoset polymers are solids like that of the molding compound used in semiconductors and integrated circuits (IC's). The term “thermosetting polymer” or “thermosetting polymer precursor” is sometimes used to describe a polymer precursor used to form a thermoset polymer. Thermosetting polymer precursors may be in a soft solid or viscous state that changes irreversibly into an infusible, insoluble polymer network by curing through application of heat, chemical reaction, or suitable radiation to the precursor.

Thermoset polymers and their precursors are distinguished from thermoplastics in that a thermoplastic, also known as a thermosoftening plastic, turns to a liquid when heated and freezes to a very glassy state when cooled sufficiently.

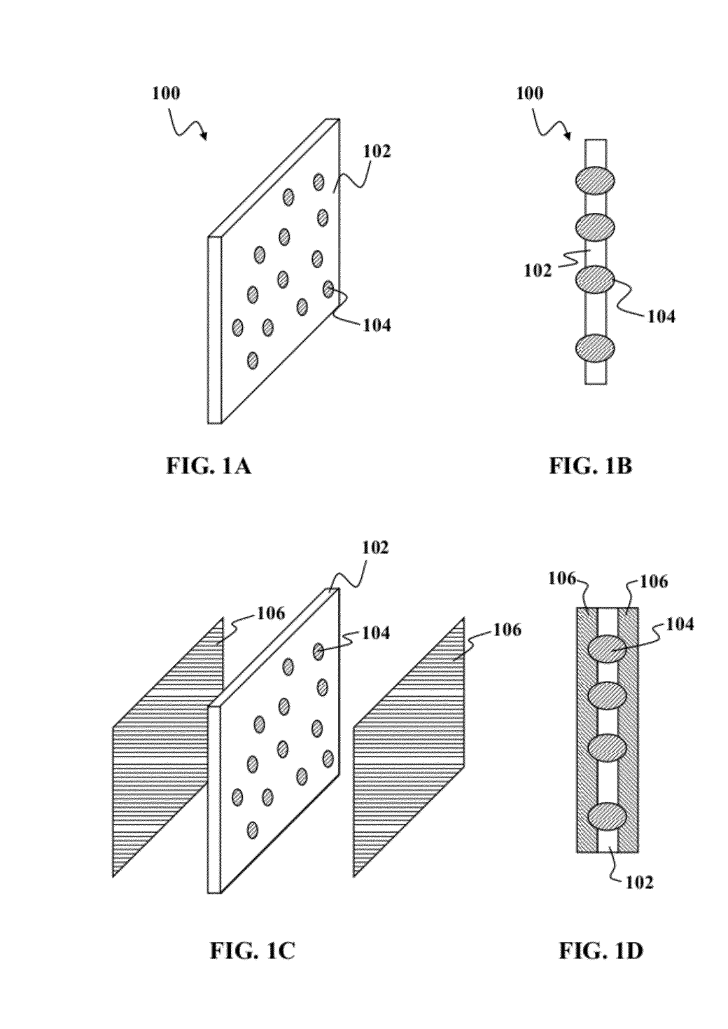

As shown in FIG. 1A and FIG. 1B, a composite substrate 100 for a bipolar battery may include a matrix 102 made of an acid-resistant thermoset polymer with conductive pellets 104 embedded in the matrix. The size d of the pellets is slightly larger than the thickness t of the matrix so that the pellets can make electrical contact with a conductive foil 106 on either side of the matrix as shown in FIG. 1C and FIG. 1D. The matrix 102 can be made from an acid-resistant thermoset polymer, e.g., polyethylene, polypropylene, polybutadiene-styrene, polyethylene terephthalate (PET), etc. The pellets 104 can be spaced apart from each other by a distance ranging from a few millimeters to a few centimeters depending on the conductivity and size of the pellets. The matrix thickness t can be about 60-70% of the pellet diameter d.

By way of example, and not by way of limitation, the foils 106 on either side of the matrix 102 can be about 50 microns thick and the matrix can be about 300 microns thick. The pellets 104 can be made of any suitable electrically conducting material, e.g., lead, or amorphous (glassy) carbon or amorphous metal. An advantage to the use of amorphous carbon pellets is that the amorphous carbon material would not have crystal domains and therefore lack of grain boundaries which are the weak points for the acid in a battery environment to corrode through the pellets. It is generally desirable for the material of the pellets to be resistant to corrosion in the acid environment of a storage battery. Resistance to corrosion is a relative term and can generally be understood in terms of the rate of corrosive reaction of the material (e.g., pure lead has a lower corrosion rate in sulfuric acid than lead alloys) and the overall dimensions of the pellets 104 (e.g., in a given corrosive environment, a thicker pellet takes longer to corrode than a thinner pellet made of the same material).

Amorphous carbon or vitreous pellets can be advantageous in spite of apparent disadvantages. Specifically, Vitreous carbon is both higher cost and has higher resistance than lead. Glassy carbon has a resistivity of 0.1 ohm-cm compared to 0.00002 ohm-cm for lead spheres. The cost of glass carbon is about 100 times higher than lead spheres on a per Kg basis. However, the disadvantage of higher resistivity can be overcome by using a sufficiently large number of amorphous carbon pellets of sufficiently large diameter so that the overall resistance of the composite substrate 100 is small. The larger diameter pellets would also take longer to corrode due to the lower reaction rate and larger size. These advantages can outweigh the cost if the resulting batter is both lighter and longer lasting.

To reduce weight, the pellets 104 may be sparsely distributed across the surface of the membrane 102. The weight can be greatly reduced since the pellets can take up less than 5% (e.g., about 1%) of the volume of the matrix. By way of example, and not by way of limitation, a volumetric ratio of the pellets to the membrane may be greater than 0% to about 10%, and preferably about 0.5% to about 1%. Even such a sparse distribution of the pellets 104 can offer a significant electrical conductivity advantage over an isotropic conductive film filled with powder fillers, such as vitreous carbon powder. The size of the conductive pellets 104 may range from about 0.1 millimeter (mm) to about 2 mm, preferably from about 0.3 mm to about 1 mm, depending on the corrosion resistance of the pellets.

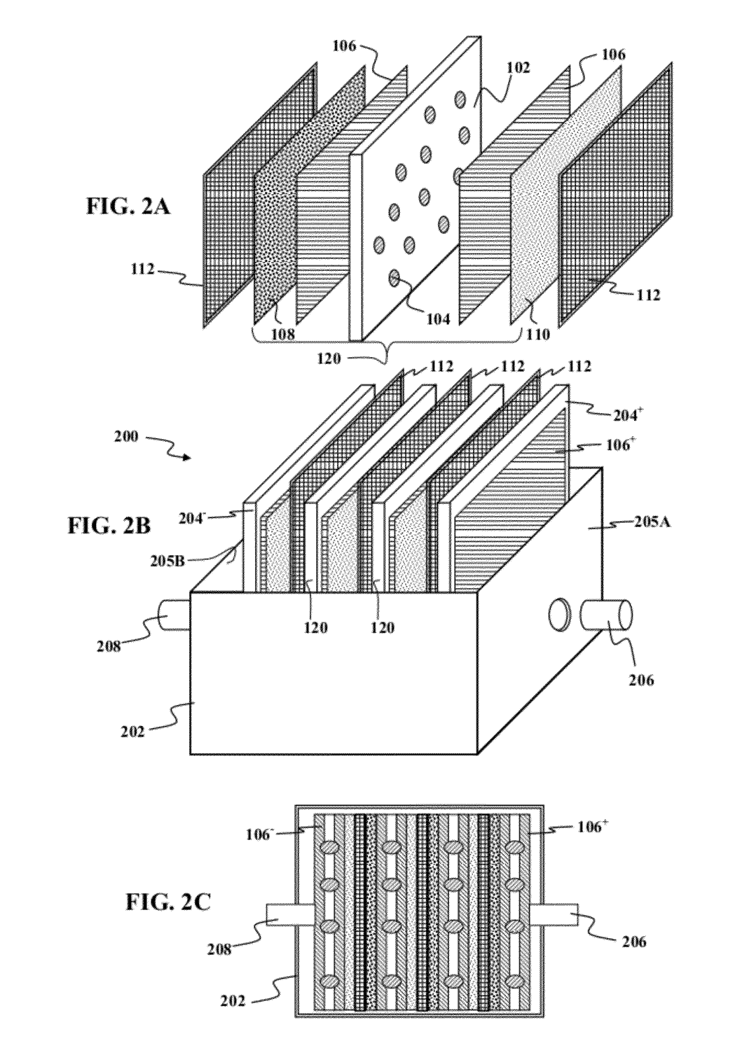

According to embodiments of the invention, the bipolar substrate 100 can be used in a bipolar battery, e.g., a bipolar lead-acid battery 200 as shown in FIGS. 2A-2C. The construction of the battery 200 is similar to a conventional bipolar battery, except for the use of the composite bipolar plate 100. As seen in FIG. 2A, the bipolar plate 100 may be used in a bipolar battery sub-component referred to herein as a cell 120. The cell generally includes the bipolar substrate 100 with the matrix 102, embedded conductive pellets 104 sandwiched between conductive foils 106. A positive active material 108 is disposed on a foil on one side of the matrix and a negative active material 110 is disposed on a foil on the opposite side. The positive and negative active materials used are well-known to the industry and may include lead-based materials, such as lead dioxide (PbO₂) for the positive active material 108 and lead (Pb), for the negative active material 110.

As seen in FIG. 2B and FIG. 2C, the battery 200 is made up of a plurality of cells 120, which are stacked in a case 202 made of a non-conductive and corrosion-resistant material, such as a plastic material. Each cell in the battery is separated from an adjacent cell by an electrolyte filled separator 112, which may include an absorbant glass mat with an electrolyte, e.g., sulfuric acid. The cells are stacked such that the active material of one polarity type (i.e., positive or negative) for one cell is separated from the opposite polarity active material in an adjacent cell. Each cell in the stack is generally configured as shown in FIG. 2A, with the exception of the cells at the ends of the stack, which have active material on only one side. Specifically, a positive end cell 204⁺ has positive active material 108 on one side facing an adjacent cell and a bare conductive foil 106⁺ with no active material facing an end wall 206A of the case 202. A conductive terminal 208 makes electrical contact with the foil 106⁺ on the side of the positive end cell 204⁺. Likewise, a negative end cell 204⁻ has negative active material 110 on one side facing an adjacent cell and a bare conductive foil 106⁻ with no active material facing an end wall 206B of the case 204. A conductive terminal 210 makes electrical contact with the foil 106⁻ on the side of the negative end cell 204⁻.

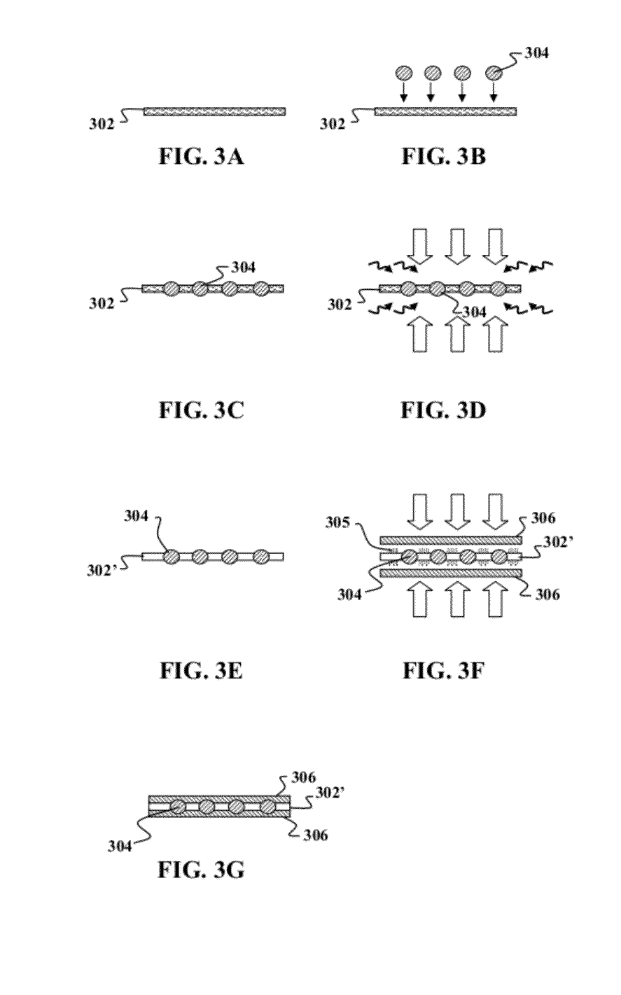

Embodiments of the present invention include a method for fabricating a substrate for a bipolar battery of the type described above. An example of such a method is illustrated in FIGS. 3A-3G. The method may begin by forming a layer of a thermosetting polymer precursor 302, as shown in FIG. 3A. Examples of precursors include but not limited to liquid or soft solid solutions of epoxies, acrylics, PMMA, or acronitrile butadiene styrene (ABS). By way of example, and not by way of limitation, the layer may be formed on a carrier in a roll-to-roll process. Alternatively, the layer may be formed in a mold in an injection molding process. Conductive pellets 304 are disposed on or in the thermosetting polymer precursor 302, as shown in FIG. 3B and FIG. 3C. In a preferred embodiment, the pellets are made of glassy or amorphous carbon that is resistant to corrosion by the electrolyte or other chemicals within a bipolar battery. The pellets 304 may be pressed into the liquid precursor layer or the precursor layer may be formed over the pellets. The thickness of the precursor layer may be controlled to ensure that the pellets protrude partly beyond the surfaces of the layer.

Once the pellets are embedded in the precursor layer 302, heat and/or pressure may be applied to the precursor as shown in FIG. 3D to cure it, thereby forming a thermoset polymer matrix 302′ with embedded conductive particles as shown in FIG. 3D. The heat and pressure applied to the precursor layer may be controlled to ensure that the pellets protrude partly beyond the surfaces of the layer. Alternatively, the precursor layer 302 may be cured by application of suitable radiation or though chemical reaction. By forming the thermoset polymer matrix 302′ about the pellets from a liquid precursor, the polymer of the matrix may be more strongly bonded to the pellets 304 so that a strong seal is formed between the pellets and the matrix. The resulting seal between the pellets and the matrix is much stronger and more reliable than a seal formed by melting and re-solidifying a thermoplastic resin around the pellets. The region of melted thermoplastic around the pellets presents a weak point through which corrosive acid may infiltrate across the matrix. By forming the matrix from a liquid thermoset polymer precursor it is possible to avoid a melted and re-solidified thermoplastic region, while retaining and enhancing the sealing function of such a region. The interfacial stress due to thermal expansion between the pellet and thermoset polymer precursor is also significantly less compared to a thermoplastic polymer due to higher degree of cross-linking in the matrix 302′.

By way of example and not by way of limitation, the pellets may be lead particles and the polymer precursor may be a thermosetting polymer precursor solution for ABS polymer.

Conductive foils 306 may be attached to opposite surfaces of the thermoset polymer matrix 302′ such that the foils make electrical contact with the conductive pellets 304. By way of example, and not by way of limitation, As shown in FIG. 3F, the pellets can make contact with the foils by slowly pressing them between the foils until the pellets make electrical contact with the foils. Adhesive 305 may be applied to the surfaces of the matrix 302′ to facilitate adhesion of the foils. The pressing can make the pellets contact the foils either by deforming the pellets (e.g., if they are made of a soft conductive material such as lead) or by indenting the foil (e.g., if the pellets are glassy carbon) such that at least one surface of the foil conforms substantially to portions of the pellets that protrude beyond the surface of the matrix 302′. It is noted that in some embodiments, the attachment of the foils may be combined with the curing of the polymer precursor. In such a case, the adhesive might not be necessary if the cured polymer makes a sufficiently good mechanical bond to the foils.

According to an alternative embodiment of the present invention, corrosion resistance of a bipolar batter substrate may be enhanced without significantly increasing weight. Corrosion resistance can generally be enhanced by increasing the path length for corrosion or by use of corrosion resistant materials. Typically, the path length for corrosion is increased by increasing the thickness of the corrodable components used in bipolar batteries. In the case of the substrate, the conventional approach to corrosion resistance is to increase the thickness of the foils (e.g., foils 106). This increases the corrosion path length in proportion to the increase in the foil thickness. However, increasing the foil thickness also increases the weight for the foils, so there is a limit to the amount of increase in the foil thickness.

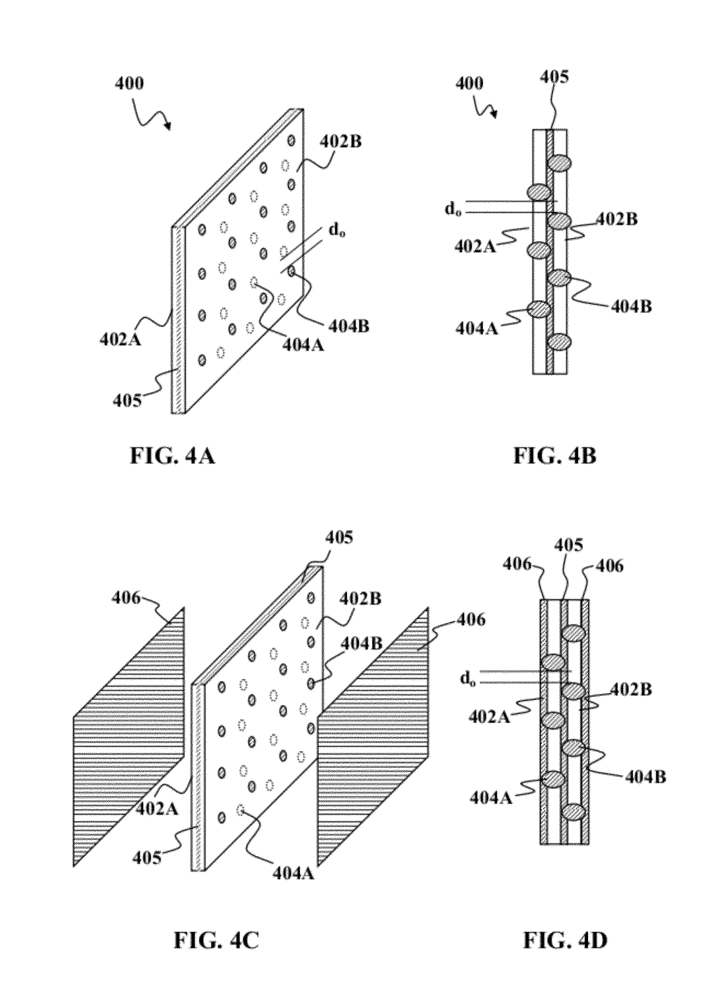

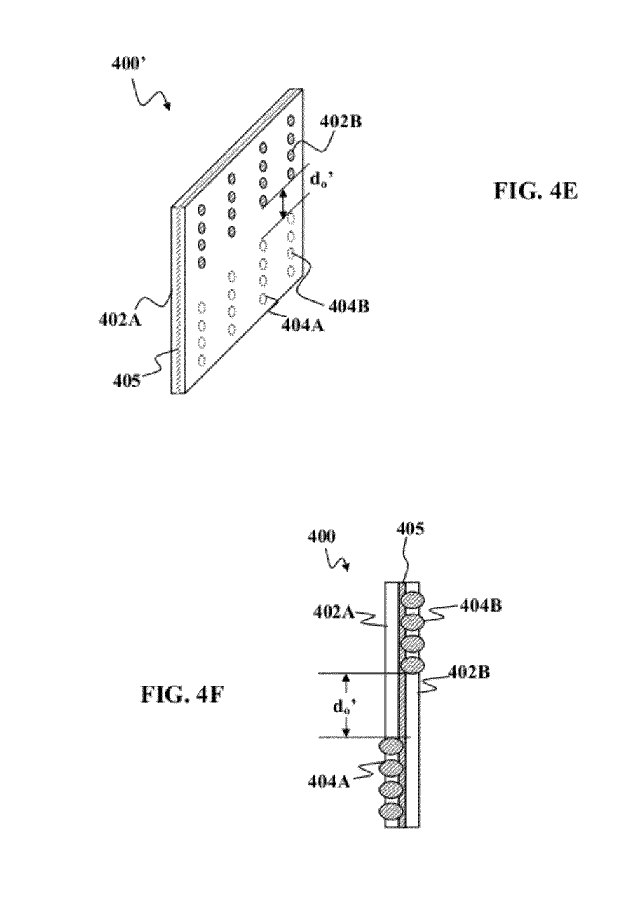

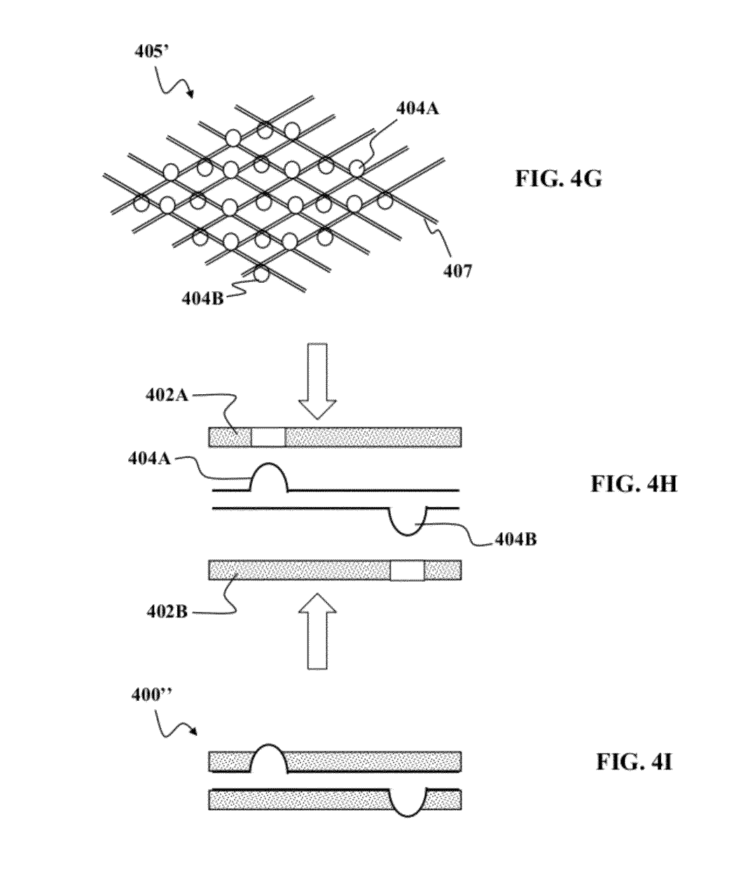

In an alternative embodiment of the present invention, the corrosion path length can be increased by an amount that is significantly greater than is possible by simply increasing the thickness of the foil. The concept behind this embodiment is illustrated in FIG. 4A-4D. As seen in FIG. 4A and FIG. 4B, a bipolar substrate 400 may be made using a thin conductive planar member 405 sandwiched between a first polymer matrix 402A and a second polymer matrix 402B. A first set of one or more conductive pellets 404A (shown in phantom in FIG. 4A) is disposed in the first polymer matrix 402A. Each conductive pellet 404A has a characteristic thickness that is greater than a thickness of the matrix 402A. As a result each pellet 402A in the first set protrudes beyond first and second surfaces of the first matrix 402A. In a like manner, a second set of one or more conductive pellets 404B is disposed in the second polymer matrix 402B. Again, each pellet 404B has a characteristic thickness greater than the thickness of the matrix 402B and the pellets 404B protrude beyond first and second surfaces of the second matrix 402B. The combination of the polymer matrices 402A, 402B and the planar conductive member 405 may be sandwiched between outer electrodes 406, e.g., in the form of conductive foils, as shown in FIG. 4C and FIG. 4D.

The planar conductive member 405 is sandwiched between the first and second matrices 402A, 402B such that it is in electrical contact with the conductive pellets 404A, 404B. The planar conductive member may be a conductive foil made of a suitable material, e.g., lead. However, the planar conductive member may alternatively be a mesh or grid made of conductive material. By way of example, and not by way of limitation, the mesh or grid may be characterized by a grid spacing that is smaller than a diameter of the conductive pellets 404A, 404B to ensure good electrical contact between the pellets and the mesh or grid. The first and second sets of conductive pellets are laterally offset with respect to each other by an offset distance dₒ thereby increasing a corrosion path length for the substrate by an amount of the offset distance. This offset distance can be made significantly greater than the thickness of the planar conductive member 405 and polymer matrices 402A, 402B. Consequently, the corrosion path length can be increased by an amount that is substantially greater than the increase in thickness of the substrate 400.

There are a number of different possible configurations for the offset between the two sets of conductive pellets 404A, 404B. For example, as shown in FIG. 4E, the conductive pellets in the two sets may be arranged in regular patterns that interdigitate with respect to each other so that pellets in the pattern for one set align with gaps where there are no pellets in the pattern for the other set. As a practical matter, this may limit the offset distance dₒ to about half the inter-pellet spacing within one set or the other. However, depending on the size of the matrices 402A, 402B and the pellets 404A, 404B the inter-pellet spacing can be made quite large compared to the thickness of the substrate. However, the offset distance dₒ can easily exceed the thickness of the planar conductive member 405 by a factor of 10 or more.

FIG. 4F illustrates another possible configuration for the offset between the two sets of conductive pellets 404A, 404B. In this configuration, referred to herein as a “non-overlapping” configuration, the two sets of conductive pellets are arranged in patterns that do not overlap with each other. This allows the entire pattern for one set of pellets 404A to be offset by a considerable distance dₒ′ with respect to the pattern for the other set of pellets 404B. Such a large offset distance dₒ′ may be on the order of a centimeter or more, depending on the dimensions of the polymer matrices 402A, 402B.

There are a number of other different possible configurations for a substrate for a bipolar battery. For example, in one alternative configuration, depicted in FIG. 4G through FIG. 4I, the conductive pellets 404A, 404B may be incorporated into a planar conductive member 405′. Specifically, the conductive pellets 404A, 404B can be cast, welded, soldered, or otherwise attached onto opposite sides of a conductive grid 407 in an alternating configuration where the conductive pellets make electrical contact with the grid. The resulting planar conductive member 405′ may be sandwiched between polymer matrices 402A, 402B as shown in FIG. 4H, e.g., by a lamination process to produce a substrate 400″ as shown in FIG. 4I. The polymer matrices 402A, 402B may include openings that are positioned and sized to receive the conductive pellets 404A, 404B, respectively. A thickness of the polymer matrices 402A, 402B is small enough that the conductive pellets 404A, 404B protrude slightly beyond the outer surfaces of the polymer matrices in the finished substrate 400″.

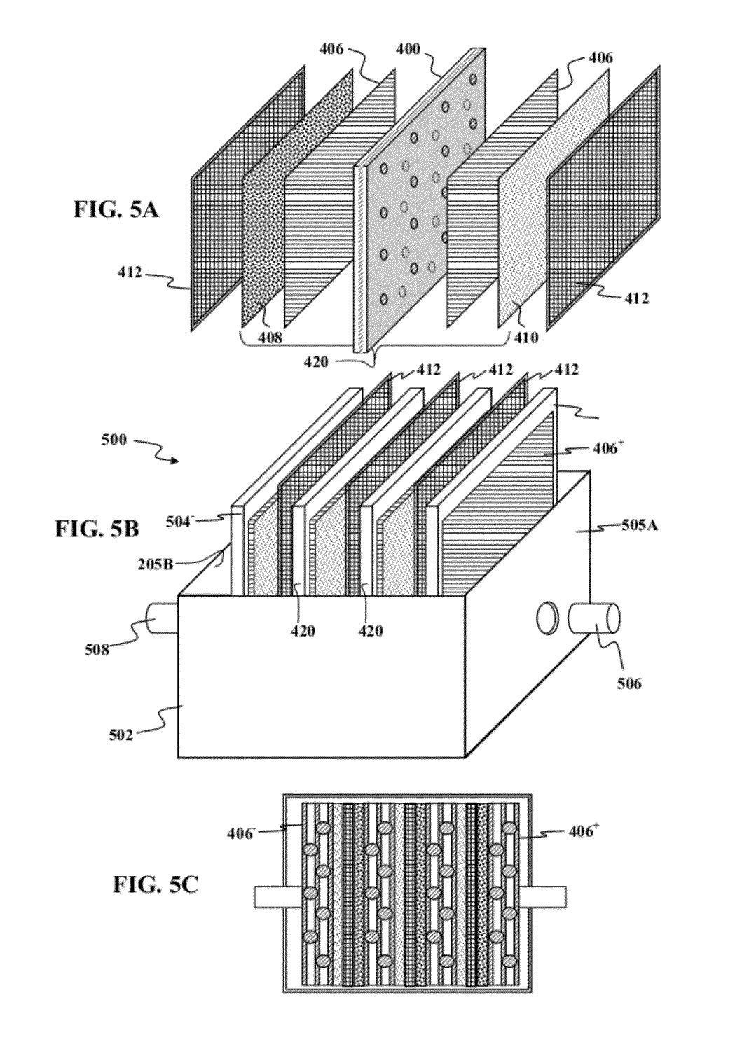

According to alternative embodiments of the invention, the bipolar substrate 400 can be used in a bipolar battery, e.g., a bipolar lead-acid battery 500 as shown in FIGS. 5A-5C. The construction of the battery 500 is similar to the bipolar battery 200 of FIGS. 2A-2C, except for the use of the composite bipolar substrate 400. As seen in FIG. 5A, the bipolar substrate 400 may be used in a bipolar battery cell 420 that generally includes the bipolar substrate 400 with the planar conductive member 405 sandwiched between matrices 402A, 402B having embedded conductive pellets 404A, 404B embedded therein. The substrate can be configured as described above with respect to any of FIGS. 4A-4I or combinations thereof. The substrate 400 can be sandwiched between conductive foils 406. A positive active material 408 (e.g., PbO₂) is disposed on a foil on one side of the matrix and a negative active material 410 (e.g., Pb) is disposed on a foil on the opposite side.

A plurality of cells 420 can make up the battery 500 as seen in FIG. 5B and FIG. 5C. The cells 420 are stacked in a case 502 made of a non-conductive and corrosion-resistant material, such as a plastic material. Each cell in the battery is separated from an adjacent cell by an electrolyte filled separator 512, e.g., an absorbant glass mat with an electrolyte, e.g., sulfuric acid. The cells 420 can be stacked such that the active material of one polarity type (i.e., positive or negative) for one cell is separated from the opposite polarity active material in an adjacent cell. The cells at the ends of the stack have active material on only one side. Specifically, a positive end cell 504⁺ has positive active material 508 on one side facing an adjacent cell and a bare conductive foil 406⁺ with no active material facing an end wall 506A of the case 502. A conductive terminal 508 makes electrical contact with the foil 406⁺ on the side of the positive end cell 504⁺. Likewise, a negative end cell 504⁻ has negative active material 510 on one side facing an adjacent cell and a bare conductive foil 406⁻ with no active material facing an end wall 506B of the case 504. A conductive terminal 510 makes electrical contact with the foil 406⁻ on the side of the negative end cell 504⁻.

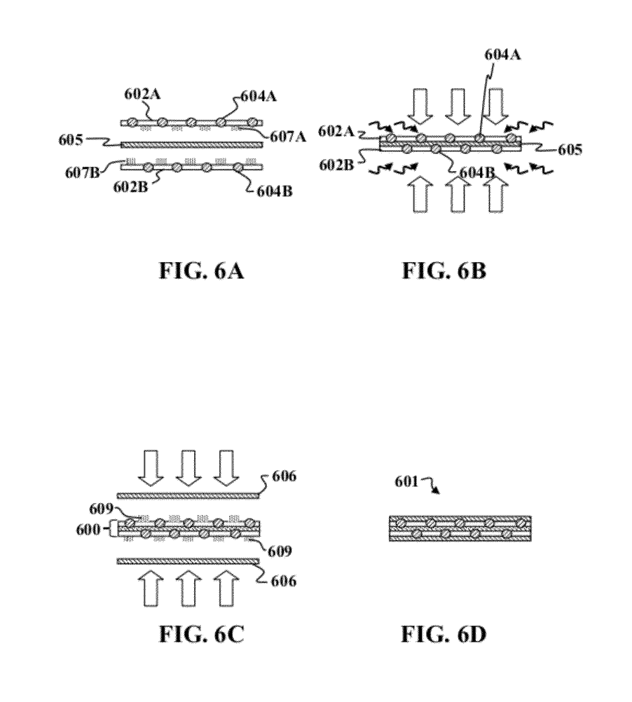

Embodiments of the present invention include a method for fabricating a substrate for a bipolar battery of the type described above with respect to FIG. 4A-4I. An example of such a method is illustrated in FIGS. 6A-6D. The method may begin by forming the first and second polymer matrices 602A, 602B and embedding conductive pellets 604A, 604B in the matrices. One or more of the polymer matrices 602A, 602B may be formed, e.g., from layer of a thermosetting polymer precursor, as described above. The conductive pellets can be disposed on or in the thermosetting polymer precursor, e.g., by pressing them into the liquid precursor layer or the precursor layer may be formed over the pellets. The thickness of the precursor layer may be controlled to ensure that the pellets protrude partly beyond the surfaces of the layer. Heat and/or pressure may then be applied to the precursor to cure it, thereby forming a thermoset polymer matrix with embedded conductive particles.

Alternatively, one or more of the polymer matrices 602A, 602B may be formed from a sheet of thermoplastic polymer. Holes may be formed in the thermoplastic polymer, e.g., by molding or punching, and the pellets may be pressed into the holes. Heat and pressure may then be applied to partially melt the polymer around the pellets. The pellets may be securely embedded when the polymer re-solidifies around the pellets.

The planar conductive member 605 may be disposed between the polymer matrices with embedded conductive pellets as shown in FIG. 6A. The patterns of the conductive pellets 604A, 604B in the matrices 602A, 602B can be arranged such that there is an offset between the pellets. Heat and pressure may be applied to sandwich the planar conductive member between the polymer matrices to form the substrate 600 as shown in FIG. 6B. If the matrices are made of thermoplastic polymer, the polymer may melt and adhere to the material of the conductive member 605. This is particularly effective if the planar conductive member is a mesh or grid. Alternatively, patterns of adhesive 607 may be applied to the matrices or to the conductive member prior to applying heat and/or pressure. The use of adhesive 607 may be more effective than heat and pressure alone to provide adhesion between thermoset polymer matrices 602A, 602B and the conductive member 605.

It is noted that in some embodiments, the sandwiching of the conductive member 605 between the polymer matrices 604A, 604B may be combined with the curing of the polymer precursor. In such a case, the adhesive might not be necessary if the cured polymer makes a sufficiently good mechanical bond to the foils.

In some embodiments, it may be desirable to add outer electrodes to the substrate 600. The substrate can be disposed between sheets of conductive material 606, e.g., lead foil, as shown in FIG. 6C and, if necessary, adhesive 607 may be applied. Heat and pressure may then be applied to sandwich the conductive material 606 to the substrate 600 to form a finished substrate 601.

Embodiments of the invention provide for a highly corrosion resistant and low weight substrate for a bipolar battery that can be manufactured at relatively low cost. It is believed that the use of a thermoset polymer in conjunction with conductive pellets in a bipolar substrate for a storage battery can provide a long-lasting battery that develops no pinhole permeability in the substrate after 350 or more 80% depth-of-discharge cycles.

The reader's attention is directed to all papers and documents which are filed concurrently with this specification and which are open to public inspection with this specification, and the contents of all such papers and documents incorporated herein by reference.

All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.” Any feature described herein, whether preferred or not, may be combined with any other feature, whether preferred or not.

What is claimed is:

1. A substrate for a bipolar battery, comprising:
a matrix made of a thermoset polymer formed from a liquid precursor; and
one or more conductive pellets disposed in the matrix, wherein each conductive pellet has a characteristic thickness that is greater than a thickness of the matrix, wherein each of the one or more conductive pellets protrudes beyond first and second surfaces of the matrix.

2. The substrate of claim 1, wherein the one or more conductive pellets include pellets of an amorphous conductive material.

3. The substrate of claim 2 wherein the amorphous conductive material is amorphous carbon, amorphous lead, or glassy metal.

4. The substrate of claim 2, wherein a volumetric ratio of the pellets to the matrix is between 0% and 10%.

5. The substrate of claim 4, wherein the volumetric ratio is between 0.5% and 1%.

6. The substrate of claim 2 wherein a size of the conductive pellets is between about 0.1 millimeters and about 2 millimeters.

7. The substrate of claim 6 wherein the size of the conductive pellets is between about 0.3 millimeters and about 1 millimeter.

8. The substrate of claim 1, further comprising a first conductive foil attached to the first surface of the matrix, wherein the first conductive foil makes electrical contact with portions of the one or more conductive pellets that protrude beyond the first surface.

9. The substrate of claim 8 wherein at least one surface of the first conductive foil substantially conforms to the first surface and portions of the one or more conductive pellets that protrude beyond the first surface.

10. The substrate of claim 8, further comprising second conductive foil attached to the second surface of the matrix, wherein the matrix and one or more conductive pellets are sandwiched between the first and second conductive foils, wherein the second conductive foil makes electrical contact with portions of the one or more conductive pellets that protrude beyond the second surface.

11. A bipolar battery, comprising;
one or more battery cells, wherein each cell comprises a substrate sandwiched between first and second acid glass mats, a positive active material disposed on the first active glass matt and a negative active material disposed on the second acid glass matt, wherein the substrate includes a matrix made of a thermoset polymer formed from a liquid precursor, one or more conductive pellets disposed in the matrix, and first and second conductive foils respectively attached to first and second surfaces of the matrix, wherein the first and second conductive foils respectively make electrical contact with portions of the conductive pellets that protrude beyond the first and second surfaces, wherein each conductive pellet has a characteristic thickness that is greater than a thickness of the matrix, wherein each of the one or more conductive pellets protrudes beyond the first and second surfaces of the matrix.

12. The battery of claim 11 wherein the one or more conductive pellets include pellets of an amorphous conductive material.

13. The battery of claim 12 wherein the amorphous conductive material is amorphous carbon, amorphous lead, or glassy metal.

14. The battery of claim 12, wherein a volumetric ratio of the pellets to the matrix is between 0% and 10%.

15. The battery of claim 14, wherein the volumetric ratio is between 0.5% and 1%.

16. The battery of claim 12 wherein a size of the conductive pellets is between about 0.1 millimeters and about 2 millimeters.

17. The battery of claim 16 wherein the size of the conductive pellets is between about 0.3 millimeters and about 1 millimeter.

18. A method for fabricating a substrate for a bipolar battery, comprising:
disposing one or more conductive pellets in a layer of a thermosetting polymer precursor; and
irreversibly curing the thermoset polymer precursor to form a thermoset polymer matrix having the one or more conductive pellets embedded in the matrix, wherein each conductive pellet has a characteristic thickness that is greater than a thickness of the matrix, wherein each of the one or more conductive pellets protrudes beyond first and second surfaces of the matrix.

19. The method of claim 18, wherein the one or more conductive pellets include pellets of an amorphous conductive material.

20. The method of claim 19 wherein the amorphous conductive material is amorphous carbon, amorphous lead, or glassy metal.

21. The method of claim 19, wherein a volumetric ratio of the pellets to the matrix is between 0% and 10%.

22. The method of claim 21, wherein the volumetric ratio is between 0.5% and 1%.

23. The method of claim 19 wherein a size of the conductive pellets is between about 0.1 millimeters and about 2 millimeters.

24. The method of claim 23 wherein the size of the conductive pellets is between about 0.3 millimeters and about 1 millimeter.

25. The method of claim 1, further comprising attaching a first conductive foil to the first surface of the matrix, wherein the first conductive foil makes electrical contact with portions of the one or more conductive pellets that protrude beyond the first surface.

26. The substrate of claim 25 wherein at least one surface of the first conductive foil substantially conforms to the first surface and portions of the one or more conductive pellets that protrude beyond the first surface.

27. The substrate of claim 25, further comprising attaching a second conductive foil to the second surface of the matrix, wherein the second conductive foil makes electrical contact with portions of the one or more conductive pellets that protrude beyond the second surface, wherein the matrix and one or more conductive pellets are sandwiched between the first and second conductive foils.

28. A substrate for a bipolar battery, comprising:
a first polymer matrix having a first set of one or more conductive pellets disposed in the first polymer matrix, wherein each conductive pellet has a characteristic thickness that is greater than a thickness of the second polymer matrix, wherein each of the one or more conductive pellets in the first set protrudes beyond first and second surfaces of the matrix;
a second polymer matrix having a second set of one or more conductive pellets disposed in the second polymer matrix, wherein each conductive pellet has a characteristic thickness that is greater than a thickness of the second polymer matrix, wherein each of the one or more conductive pellets in the first set protrudes beyond first and second surfaces of the second polymer matrix,
a planar conductive member sandwiched between the first polymer matrix and the second polymer matrix in electrical contact with the conductive pellets of the first and second polymer matrices,
wherein first and second sets of conductive pellets are laterally offset with respect to each other by an offset distance thereby increasing a corrosion path length for the substrate by an amount of the offset distance.

29. The substrate of claim 28, wherein one or more of the first and second polymer matrices is made of a thermoset polymer formed from a liquid precursor.

30. The substrate of claim 28, wherein the planar conductive member is a conductive foil.

31. The substrate of claim 28, wherein the planar conductive member is a conductive mesh.

32. The substrate of claim 31, wherein the conductive pellets are incorporated into the conductive mesh.

33. The substrate of claim 28, wherein the first and second sets of conductive pellets are laterally offset in an interdigitating manner.

34. The substrate of claim 28, wherein the first and second sets of conductive pellets are laterally offset in a non-overlapping manner.

35. The substrate of claim 28, wherein the first or second polymer matrix is made of a thermoset polymer formed from a liquid precursor.

36. The substrate of claim 28, wherein the first or second polymer matrix is made of a thermoplastic polymer.
